(19) United States
(12) Patent Application Publication
(10) Pub. No.: US 2026/0328665 A1
(43) Pub. Date: Oct. 22, 2026

(54) TENSION TESTING TOOL AND ASSOCIATED SYSTEM AND METHOD

(71) Applicant: The Boeing Company, Arlington, VA (US)

(72) Inventors: Kevin Reyes, St. Louis, MO (US); Cynthia Jarvis, St. Louis, MO (US); Joshua Anders, Chesterfield, MO (US); Eric Zuelke, St. Charles, MO (US); Robert Funke, JR., Wildwood, MO (US)

(21) Appl. No.: 19/182,271

(22) Filed: Apr. 17, 2025

(51) Int. Cl. G01N 3/08; G01N 3/02; G01N 3/20

(52) U.S. Cl. CPC G01N 3/08; G01N 3/02; G01N 3/20; G01N 2203/04

(57) ABSTRACT

Disclosed herein is a tension testing tool for evaluating mechanical characteristics of a composite testing specimen under combined axial and bending loads and an associated system and method. The tension testing tool includes first and second test fixtures arranged in a mirrored orientation across a central plane, each having a main body and a backing plate to secure the testing specimen. A load application arm is attached to each test fixture via an arm-attachment opening. The test fixtures are configured to be removably secured to a testing frame, which applies a force to at least one of the load application arms along a longitudinal axis to assess interlaminar strength, deformation behavior, and failure mechanisms in the testing specimen.

### FIELD

This disclosure relates generally to material testing systems and more particularly to a tension testing tool for evaluating mechanical characteristics in a testing specimen.

### BACKGROUND

The demand for complex composite components in industries, such as aerospace, is rapidly increasing due to their lightweight, high-strength, and energy-absorbing properties. Evaluating the mechanical properties of these advanced structures is important to ensure their performance and reliability. However, conventional testing methods for composite structures are often time-consuming, costly, and designed for small-scale specimens. As such, these methods may not adequately account for the structural behavior of larger composite components with complex geometries and large radii. As a result, conventional testing methods may introduce artificial constraints or fail to reflect real-world loading conditions, which can lead to inaccurate or incomplete results.

### SUMMARY

The subject matter of the present application has been developed in response to the present state of the art, and in particular, in response to the shortcomings in material testing systems and methods that have not yet been fully solved by currently available techniques. Accordingly, the subject matter of the present application has been developed to provide a tension testing tool, and associated system and method, that overcome at least some of the above-mentioned shortcomings of prior art techniques.

The following is a non-exhaustive list of examples, which may or may not be claimed, of the subject matter, disclosed herein.

Disclosed herein is a tension testing tool including a first test fixture and a second test fixture. Each test fixture comprises a main body that includes an arm-attachment opening and a first retention surface. Each test fixture also includes a backing plate including a second retention surface. Fasteners are configured to removably secure the backing plate to the main body. A load application arm is removably attachable to the arm-attachment opening of the main body. The first retention surface of the main body and the second retention surface of the backing plate are spaced apart and face each other when the fasteners removably secure the backing plate to the main body. A gap is defined between the first retention surface and the second retention surface. The gap is configured to receive and retain a testing specimen. The first test fixture and the second test fixture are spaced apart and mirror each other across a central plane. The preceding subject matter of this paragraph characterizes example 1 of the present disclosure.

At least one of the first test fixture is configured to move along a longitudinal axis in a first direction, perpendicular to the central plane, in response to a first applied force and the second test fixture is configured to move along the longitudinal axis in a second direction, opposite the first direction, in response to a second applied force equal to the first applied force. The preceding subject matter of this paragraph characterizes example 2 of the present disclosure, wherein example 2 also includes the subject matter according to example 1, above.

Each of the first test fixture and the second test fixture includes a pin configured to extend through the arm-attachment opening of the main body and an opening in the load application arm. The preceding subject matter of this paragraph characterizes example 3 of the present disclosure, wherein example 3 also includes the subject matter according to any of examples 1-2, above.

For each of the first test fixture and the second test fixture, the load application arm is pivotable relative to the main body when the load application arm is attached to the arm-attachment opening of the main body. The preceding subject matter of this paragraph characterizes example 4 of the present disclosure, wherein example 4 also includes the subject matter according to any of examples 1-3, above.

Each of the first test fixture and the second test fixture includes multiple arm-attachment openings. The arm-attachment opening is one of the arm-attachment openings. The preceding subject matter of this paragraph characterizes example 5 of the present disclosure, wherein example 5 also includes the subject matter according to any of examples 1-4, above.

For each of the first test fixture and the second test fixture, the arm-attachment openings include a first arm-attachment opening and a second arm-attachment opening. The first arm-attachment opening is positioned further away from the first retention surface of the main body than the second arm-attachment opening. The preceding subject matter of this paragraph characterizes example 6 of the present disclosure, wherein example 6 also includes the subject matter according to any of examples 1-5, above.

For at least one of the first test fixture and the second test fixture, when the load application arm is attached to the first arm-attachment opening, a force applied to the load application arm is transmitted through the main body as a combination of a first bending and axial load. When the load application arm is attached to the second arm-attachment opening, the force applied to the load application arm is transmitted through the main body as a combination of a second bending and axial load. The first bending and axial load is different from the second bending and axial load. The preceding subject matter of this paragraph characterizes example 7 of the present disclosure, wherein example 7 also includes the subject matter according to example 6, above.

The first retention surface of the main body of the first test fixture is positioned at an oblique angle relative to the first retention surface of the main body of the second test fixture. The preceding subject matter of this paragraph characterizes example 8 of the present disclosure, wherein example 8 also includes the subject matter according to any of examples 1-7, above.

The first test fixture and the second test fixture are configured to be repositionable relative to each other while maintaining the mirrored orientation across the central plane. The preceding subject matter of this paragraph characterizes example 9 of the present disclosure, wherein example 9 also includes the subject matter according to any of examples 1-8, above.

Further disclosed herein is a tension testing system including a first test fixture and a second test fixture. Each test fixture includes a main body having an arm-attachment opening and a first retention surface, a backing plate with a second retention surface, fasteners configured to removably secure the backing plate to the main body, and a load application arm removably attachable to the arm-attachment opening of the main body. The system further includes a testing frame. During testing, the first test fixture and the second test fixture are removably secured to the testing frame, such that the first test fixture and the second test fixture are spaced apart and mirror each other across a central plane. The first retention surface of the main body of the first test fixture is positioned at an oblique angle relative to the first retention surface of the main body of the second test fixture. A first attachment portion of a testing specimen is removably secured between the first retention surface of the main body and the second retention surface of the backing plate of the first test fixture. A second attachment portion of the testing specimen is removably secured between the first retention surface of the main body and the second retention surface of the backing plate of the second test fixture. The first attachment portion is spaced apart from the second attachment portion by an intermediate testing portion of the testing specimen. The testing frame applies a force to at least one of the load application arms of the first test fixture and the load application arm of the second test fixture along a longitudinal axis to assess mechanical characteristics in the testing specimen. The preceding subject matter of this paragraph characterizes example 10 of the present disclosure.

At least one of the first test fixture is configured to move along the longitudinal axis in a first direction, perpendicular to the central plane, in response to a first applied force and/or the second test fixture is configured to move along the longitudinal axis in a second direction, opposite to the first direction, in response to a second applied force equal to the first applied force. The preceding subject matter of this paragraph characterizes example 11 of the present disclosure, wherein example 11 also includes the subject matter according to example 10, above.

The first test fixture and the second test fixture are adjustably positionable relative to the testing frame and to each other to accommodate testing specimens of various sizes. The preceding subject matter of this paragraph characterizes example 12 of the present disclosure, wherein example 12 also includes the subject matter according to any of examples 10-11, above.

The testing frame includes a load application system configured to control the magnitude of the force and the rate at which the force is applied to at least one of the load application arm of the first test fixtures and the load application arm second test fixture. The preceding subject matter of this paragraph characterizes example 13 of the present disclosure, wherein example 13 also includes the subject matter according to any of examples 10-12, above.

Each of the first test fixture and the second test fixture includes multiple arm-attachment openings. The arm-attachment opening is one of the multiple arm-attachment openings. The preceding subject matter of this paragraph characterizes example 14 of the present disclosure, wherein example 14 also includes the subject matter according to any of examples 10-13, above.

Each one of the first test fixture and the second test fixture are positionable relative to each other in different mirrored orientations within the testing frame. The tension testing system is configured to operate in at least one of an axial-dominant condition, a balanced loading condition, or a bending-dominant condition. Operation in one of these conditions is based at least partially on the mirrored orientation of the first and second test fixtures relative to the testing frame and the selected arm-attachment opening to which the load application arm is attached. The preceding subject matter of this paragraph characterizes example 15 of the present disclosure, wherein example 15 also includes the subject matter according to example 14, above.

Further disclosed herein is a method of performing a tension test on a testing specimen includes attaching a first load application arm to a main body of a first test fixture and a second load application arm to a main body of a second test fixture via an arm-attachment opening in each main body. The method also includes removably securing the first test fixture and the second test fixture to a testing frame, such that the first test fixture and the second test fixture are spaced apart and mirror each other across a central plane. The method further includes securing a first attachment portion of a testing specimen between a first retention surface of the main body of the first test fixture and a second retention surface of a backing plate of the first test fixture. Additionally, the method includes securing a second attachment portion of the testing specimen between a first retention surface of the main body of the second test fixture and a second retention surface of a backing plate of the second test fixture. The first attachment portion is spaced apart from the second attachment portion by an intermediate testing portion of the testing specimen. The method finally includes applying a force to at least one of the first load application arm and the second load application arm along a longitudinal axis to assess mechanical characteristics in the testing specimen. The preceding subject matter of this paragraph characterizes example 16 of the present disclosure.

Each of the first test fixture and the second test fixture includes multiple arm-attachment openings, where the arm-attachment opening is one of these multiple openings. Each of the arm-attachment openings in the first test fixture has a corresponding arm-attachment opening in the second test fixture that is positioned in a mirrored orientation across the central plane. The step of attaching the first and second load application arms includes attaching the first load application arm to a selected one of the arm-attachment openings in the first test fixture and attaching the second load application arm to a corresponding one of the arm-attachment openings in the second test fixture. The preceding subject matter of this paragraph characterizes example 17 of the present disclosure, wherein example 17 also includes the subject matter according to example 16, above.

The method includes selecting a mirrored orientation of the first test fixture and the second test fixture relative to the testing frame. The step of applying the force to at least one of the first and second load application arms results in at least one of an axial-dominant condition, a balanced loading condition, or a bending-dominant condition, based at least partially on the mirrored orientation of the first test fixture and the second test fixture relative to the testing frame and the selected arm-attachment openings to which the load application arms are attached. The preceding subject matter of this paragraph characterizes example 18 of the present disclosure, wherein example 18 also includes the subject matter according to example 17, above.

The step of applying the forces includes controlling the magnitude of the force and the rate at which the force is applied to at least one of the load application arms of the first and second test fixtures. The preceding subject matter of this paragraph characterizes example 19 of the present disclosure, wherein example 19 also includes the subject matter according to any of examples 16-18, above.

The method includes adjusting the position of the first test fixture and the second test fixture relative to each other and relative to the testing frame to accommodate the size of the testing specimen. The preceding subject matter of this paragraph characterizes example 20 of the present disclosure, wherein example 20 also includes the subject matter according to any of examples 16-19, above.

The described features, structures, advantages, and/or characteristics of the subject matter of the present disclosure may be combined in any suitable manner in one or more examples and/or implementations. In the following description, numerous specific details are provided to impart a thorough understanding of examples of the subject matter of the present disclosure. One skilled in the relevant art will recognize that the subject matter of the present disclosure may be practiced without one or more of the specific features, details, components, materials, and/or methods of a particular example or implementation. In other instances, additional features and advantages may be recognized in certain examples and/or implementations that may not be present in all examples or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

In order that the advantages of the subject matter may be more readily understood, a more particular description of the subject matter briefly described above will be rendered by reference to specific examples that are illustrated in the appended drawings. Understanding that these drawings, which are not necessarily drawn to scale, depict only certain examples of the subject matter and are not therefore to be considered to be limiting of its scope, the subject matter will be described and explained with additional specificity and detail through the use of the drawings, in which:

FIG. 1 is a schematic side view of one example of a tension testing tool, with a first test fixture and a second test fixture spaced apart across a central plane, according to one or more examples of the present disclosure;

FIG. 2 is a schematic side view of a main body and load application arm of the first test fixture of FIG. 1, according to one or more examples of the present disclosure;

FIG. 3A is a schematic side view of a backing plate of the first test fixture of FIG. 1, according to one or more examples of the present disclosure;

FIG. 3B is a schematic rear elevation view of the backing plate of FIG. 3A, according to one or more examples of the present disclosure;

FIG. 4A is a schematic side view of one example of a tension testing tool, with a testing specimen secured within a first test fixture and a second test fixture, and the tension testing tool in an axial-dominant condition, according to one or more examples of the present disclosure;

FIG. 4B is a schematic side view of the tension testing tool of FIG. 4A, with the tension testing tool in a balanced loading condition, according to one or more examples of the present disclosure;

FIG. 4C is a schematic side view the tension testing tool of FIG. 4A, with the tension testing tool in a bending-dominant condition, according to one or more examples of the present disclosure;

FIG. 5 is a schematic perspective view of one example of a tension testing system, with a tension testing tool secured to a testing frame and a testing specimen secured within the tension testing tool, according to one or more examples of the present disclosure;

FIG. 6A is a schematic perspective partial view of a testing specimen within a tension testing tool, prior to a testing operation, according to one or more examples of the present disclosure;

FIG. 6B is a schematic perspective partial view of the testing specimen within the tension testing tool of FIG. 6A, after the testing operation, depicting deformation of the testing specimen, according to one or more examples of the present disclosure; and

FIG. 7 is a schematic flow diagram of a method of performing a tension test on a testing specimen, according to one or more examples of the present disclosure.

### DETAILED DESCRIPTION

Reference throughout this specification to “one example,” “an example,” or similar language means that a particular feature, structure, or characteristic described in connection with the example is included in at least one example of the present disclosure. Appearances of the phrases “in one example,” “in an example,” and similar language throughout this specification may, but do not necessarily, all refer to the same example. Similarly, the use of the term “implementation” means an implementation having a particular feature, structure, or characteristic described in connection with one or more examples of the present disclosure, however, absent an express correlation to indicate otherwise, an implementation may be associated with one or more examples.

Disclosed herein is a tension testing tool for assessing mechanical characteristics of a testing specimen and associated system and method utilizing the tension testing tool for the same. The tension testing tool is designed to test composite structures with complex and/or large radii. Composite structures of this nature may experience a combination of axial and bending loads under real-world conditions, which can induce interlaminar tension stress, delamination, and other failure mechanisms that are important to the structural integrity of the composite structure. Assessing the mechanical response of composite structures under representative loading conditions can provide valuable insight into their performance in real-world applications. Conventional testing methods often focus on rotational forces and fail to adequately capture the interaction between bending and axial forces in larger composite structures, which can limit their ability to reflect real-world structural behavior. Examples of the disclosed tension testing tool address these limitations by enabling controlled assessment of mechanical properties in a composite structure under combined loading conditions.

According to some examples, the tension testing tool includes two test fixtures arranged in a mirrored orientation relative to each other. A force is applied to at least one of the test fixtures, which transfers the force to the testing specimen, to induce bending and axial loads for the evaluation of mechanical characteristics in the testing specimen. The modular and scalable design of the tension testing tool enables multiple testing configurations by incorporating at least one of repositionable test fixtures and/or multiple arm-attachment openings. These features facilitate the characterization of different bending-to-axial force ratios and enable the tension testing tool to accommodate testing specimen of different sizes. By providing a flexible and cost-effective solution, the tension testing tool improves the accuracy and reliability of composite material assessments.

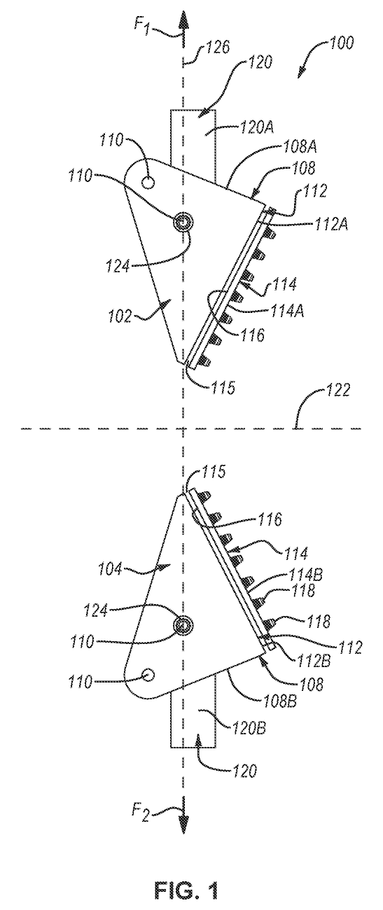

According to FIG. 1, one example of a tension testing tool 100 is shown. The tension testing tool 100 is configured to removably secure a testing specimen for assessing the mechanical characteristics of the testing specimen. As used herein, in certain examples, mechanical characteristics refer to the physical and structural properties of a material or component that influence its performance under applied forces. Mechanical characteristics can include, but are not limited to, interlaminar tension (ILT) strength, bending resistance, axial load capacity, stiffness, and overall load-bearing behavior. Mechanical characteristics may further include failure mechanisms related to delamination, crack propagation, and interlaminar stress distributions under combined loading conditions.

The tension testing tool 100 includes a first test fixture 102 and a second test fixture 104. The first test fixture 102 and the second test fixture 104 (collectively referred to as “the test fixtures 102, 104”) are spaced apart and arranged in a mirrored orientation across a central plane 122. The mirrored orientation refers to the symmetrical arrangement of the test fixtures 102, 104 across the central plane 122, such that each fixture is positioned on opposite sides of the central plane 122, with corresponding structural features facing each other (e.g., identically spaced away from and identically oriented relative to the central plane 122). This arrangement helps to ensure that when a force is applied to the test fixtures 102, 104, the resulting loads are distributed in a balanced manner across the testing specimen, to enable uniform tension testing. The spacing between the test fixtures 102, 104 accommodates a testing specimen while maintaining alignment along a longitudinal axis 126, perpendicular to the central plane 122.

Each one of the first test fixture 102 and the second test fixture 104 includes a main body 108. That is, the first test fixture 102 includes a first main body 108A and the second test fixture 104 includes a second main body 108B. The main body 108 is the primary structural component for securing and supporting a testing specimen during testing. The main body 108 includes a first retention surface 112, which serves as a contact surface for securing a testing specimen to the corresponding one of the test fixtures 102, 104. The first retention surface 112 is positioned on one side of the main body 108. In some examples, the first retention surface 112 is planar and extends along a substantial length of the main body 108 to provide a uniform contact area for securing a testing specimen. In other examples, the first retention surface 112 may be contoured to correspond with a shape of the testing specimen and enable a non-planar interface. Additionally, in some examples, the first retention surface 112 may include textured features or coatings to enhance grip and reduce slippage of a testing specimen when secured.

In some examples, a first retention surface 112A of the first main body 108A is positioned at an oblique angle relative to a first retention surface 112B of the second main body 108B. In other words, the first retention surfaces have a symmetric, non-parallel orientation relative to each other. By positioning the retention surfaces at oblique angles, the test fixtures 102, 104 constrain a secured testing specimen in a configuration that results in both bending and axial loads when a tensile force is applied to at least one of the load application arms, which helps enable evaluation of the mechanical response of the testing specimen under combined loading conditions. In other examples, the first retention surface 112A of the first main body 108A and the first retention surface 112B of the second main body 108B may be perpendicular to one another (e.g., forming a 90° angle relative to each other).

The main body 108 also includes at least one arm-attachment opening 110 configured to removably attach a load application arm 120 of the test fixture to the main body 108. The arm-attachment opening 110 is a through-hole that extends through a width of the main body 108, at an angle that is generally parallel to the central plane 122. In some examples, the arm-attachment opening 110 may be circular, elliptical, or slotted, depending on the required range of motion for the load application arm 120. The position of the arm-attachment opening 110 within the main body 108 is configured to enable attachment of the load application arm 120 at a predetermined location on main body 108. In some examples, the main body 108 includes multiple arm-attachment openings 110, such that the load application arm 120 can be removably attached to any one of the multiple arm-attachment openings 110.

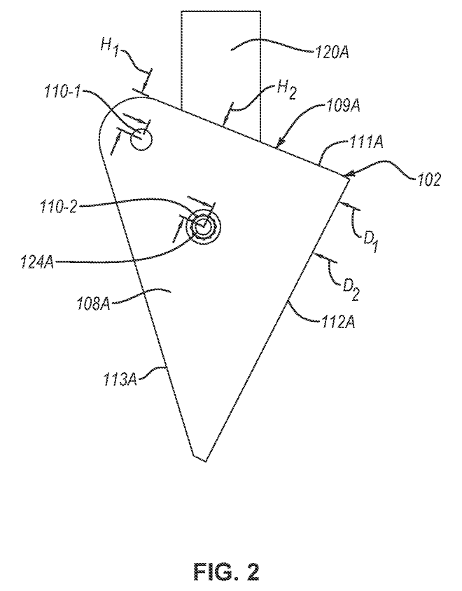

Referring to FIG. 2, the first main body 108A of the first test fixture 102 is shown. Similarly, the description of the features of the first main body 108A is equally applicable to the second main body 108B of the second test fixture 104. The first main body 108A includes multiple arm-attachment openings 110, including a first arm-attachment opening 110-1 and a second arm-attachment opening 110-2. The first arm-attachment opening 110-1 is positioned at a first distance D₁ relative to the first retention surface 112A and the second arm-attachment opening 110-2 is positioned at a second distance D₂, relative to the first retention surface 112A. As defined herein, the first distance D₁ and the second distance D₂ are defined as the shortest distance from a center of the respective one of the arm-attachment openings 110 to the first retention surface 112A. In some examples, the first distance D₁ is different than the second distance D₂. The variation in distance from any one of the arm-attachment openings 110 to the first retention surface 112 provides the ability to adjust the distribution of an applied force within the first main body 108A and correspondingly affects the resulting moment arm. Additionally, in some examples, the first arm-attachment opening 110-1 is positioned at a first height H₁ relative to a first top surface 111A and the second arm-attachment opening 110-2 is positioned at a second height H₂, relative to the first top surface 111A. As defined herein, the first height H₁ and the second height H₂ are defined as the shortest distance from a center of the respective one of the arm-attachment openings 110 to the first top surface 111A. In some examples, the first height H₁ is different than the second height H₂. The difference in height between H₁and H₂ influences the direction and distribution of the applied force through the first main body 108A, particularly in terms of how the load path passes through the fixture. In other examples, the first height H₁ may be the same as the second height H₂.

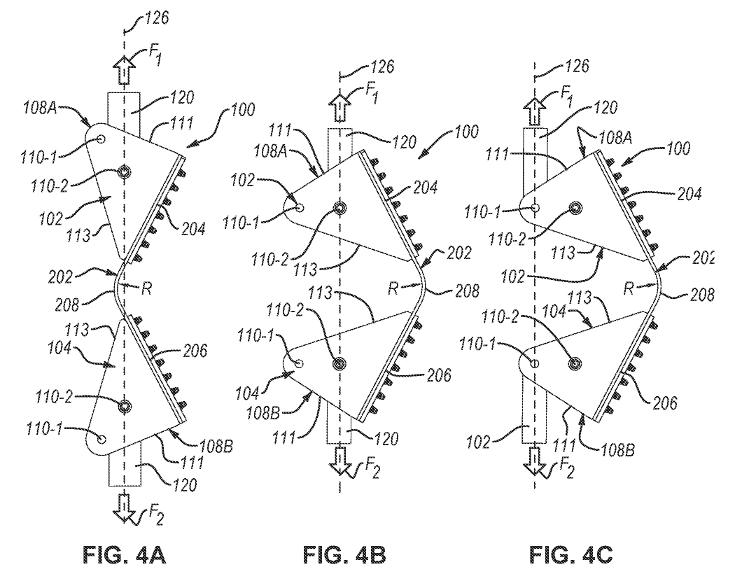

Accordingly, the selection of the arm-attachment opening 110 directly influences the transmission of forces through the main body 108 by altering a moment arm, which affects the balance between bending and axial load distribution. As used herein, the moment arm is defined as the perpendicular distance from a line of action of the applied force to the center of a radius R of a testing specimen. The line of action of the applied force is aligned with the longitudinal axis 126. For example, in the configuration shown in FIG. 4B, when the load application arm 120 is secured to the second arm-attachment opening 110-2, the applied force generates a moment about the second arm-attachment opening 110-2, which influences the magnitude of the resulting bending moment and axial load (i.e., combination of a first bending and axial load) within the main body 108. Conversely, when the load application arm 120 is secured to the first arm-attachment opening 110-1, as shown in FIG. 4C, the moment arm is longer, which shifts the ratio of bending to axial loads (i.e., combination of a second bending and axial load) experienced at the radius. The first bending and axial load is different from the second bending and axial load. That is, because the assembly is symmetric, the applied axial force results in a single bending and axial load in the testing specimen. It is noted that the specific moment arm lengths depend on the orientation of the test fixtures and the geometry of the test specimen. Further details regarding the effect of the distance and/or height of the arm-attachment openings 110 on force distribution are described with reference to FIGS. 4A-4C below.

The main body 108 may have any of various shapes. In the example shown in FIG. 2, the first main body 108A has a generally triangular shape, from a side of the first main body 108A, with a wider upper portion and a tapered lower portion. The shape, from the side, is defined by a perimeter 109A and includes the first top surface 111A, a first inclined surface 113A, and the first retention surface 112A. The second main body 108B, being a mirrored image of the first main body 108A across the central plane 122, has a wider lower portion and a tapered upper portion when the central plane 122 is parallel to horizontal. In some examples, the first top surface 111A and the first retention surface 112A are perpendicular to each other, such as in the illustrated example. The upper portion includes the arm-attachment openings 110-1 and 110-2, which are positioned near the first top surface 111A of the first main body 108A, with the arm-attachment opening 110-1 being closer to the first top surface 111A than the arm-attachment opening 110-2. The first retention surface 112A extends along one side of the first main body 108A, while the opposite side includes the first inclined surface 113A, that extends from the upper portion to the lower portion.

Referring back to FIG. 1, each one of the first test fixture 102 and the second test fixture 104 also includes a load application arm 120. More specifically, the first test fixture 102 includes a first load application arm 120A and the second test fixture 104 includes a second load application arm 120B. The load application arm 120 is removably attachable to the main body 108 via the arm-attachment opening 110. In some examples, the load application arm 120 is secured to the arm-attachment opening 110 using a pin 124, which extends through the arm-attachment opening 110 of the main body 108 and an opening in the load application arm 120 (not shown). In other examples, the load application arm 120 is secured by a fastener assembly, such as a bolt and nut combination or a quick-release pin, to enable easy removal and reattachment. In yet other examples, the load application arm 120 may be attached via a threaded engagement, where a threaded fastener can pass through the arm-attachment opening 110 and secure the load application arm 120 to the main body 108. As shown in FIG. 2, the first load application arm 120A is secured to the first main body 108A by a first pin 124A that extends through the second arm-attachment opening 110-2.

In some examples, the load application arm 120 is pivotal relative to the main body 108. By enabling relative pivoting between the load application arm 120 and the main body 108, the test fixtures 102, 104 enable application of both bending and axial forces to a testing specimen. Pivoting changes the orientation of an applied force relative to a testing specimen, thus creating a moment arm that generates bending forces in addition to axial tension. The extent of pivoting, or pivot range, is influenced by at least the selection of the arm-attachment opening to which the load application arm 120 is attached. Accordingly, pivotability of the load application arm 120 determines how applied forces are transmitted through a corresponding test fixture, while the selection of different arm-attachment openings modifies the moment arm length, thereby affecting the balance between bending and axial loads. In other examples, the load application arm 120 is fixed relative to the main body 108, such that an applied force is transmitted directly through the corresponding test fixture into a testing specimen, resulting in minimal or no bending moment.

In some examples, the load application arm 120 may have any of various shapes and sizes to be compatible with a corresponding testing frame, to ensure proper alignment for force application from the testing frame. Additionally, the load application arm 120 may be formed from any of various materials, which can be selected based on strength and rigidity requirements, such as high-strength metals to withstand applied loads without deformation. Further, the load application arm 120 may have any of various lengths, where the selected length may vary based on the intended loading conditions or compatibility with different testing frames or load application setups.

Each one of the first test fixture 102 and the second test fixture 104 also includes a backing plate 114. Specifically, the first test fixture 102 includes a first backing plate 114A, and the second test fixture 104 includes a second backing plate 114B. The backing plate 114 includes a second retention surface 116, which, together with the first retention surface 112 of the main body 108, is configured to secure a testing specimen therebetween. During testing, the first retention surface 112 and the second retention surface 116 face each other and are spaced apart to define a gap 115, to enable the testing specimen to be securely positioned between them. Accordingly, the gap 115 defined between the first retention surface 112 and the second retention surface 116 is configured to receive and retain a testing specimen. In some examples, the second retention surface 116 is configured to correspond to the first retention surface 112. For example, when the first retention surface 112 is planar, the second retention surface 116 is also planar. In other examples, when the first retention surface 112 is contoured, the second retention surface 116 has a complementary contour in a mirrored orientation. Additionally, in some examples, the second retention surface may include textured features or coatings to enhance grip and reduce slippage of a testing specimen when secured.

The backing plate 114 is removably attachable to the main body 108 via fasteners 118, which extend through corresponding openings in the backing plate 114 and are configured to align with corresponding fastener openings in the main body 108. That is, the fasteners 118 are configured to removably secure the backing plate 114 to the main body 108. In some examples, the fasteners 118 may be bolts, screws, or other mechanical fasteners that enable secure attachment to the main body 108 while enabling removal and reattachment. The removability of the backing plate 114 facilitates easy placement and removal of a testing specimen while maintaining an evenly distributed clamping force to prevent movement of a testing specimen during testing.

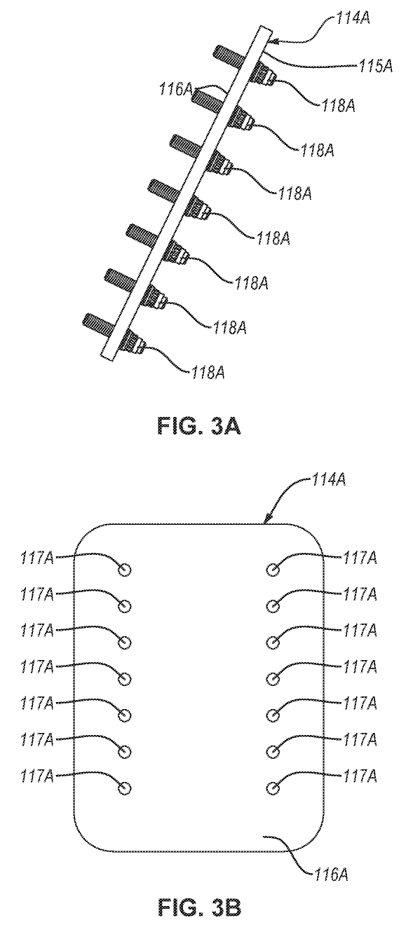

Referring to FIG. 3B, the first backing plate 114A includes multiple first fastener openings 117A. In some examples, the first fastener openings 117A may be arranged into two rows of openings each located along one of two opposing edges of the first backing plate 114A. In other examples, the first fastener openings 117A may be arranged in a single row along the first backing plate 114A. In yet other examples, the first fastener openings 117A may be arranged in different patterns or spacing configurations to accommodate various specimen sizes and clamping requirements. The first fastener openings 117A align with corresponding fastener openings in the first main body 108A (not shown) to enable the first backing plate 114A to be secured at multiple points to the first main body 108A. The first fastener openings 117A also configured to align with corresponding openings in a testing specimen (not shown). As shown in FIG. 3A, only the first backing plate 114A is shown to better illustrate the fasteners 118A extending through the corresponding first fastener openings 117A. In actual use, the fasteners 118A would extend through the first fastener openings 117A, pass through corresponding openings in the testing specimen, and engage with corresponding fastener openings in the first main body 108A to secure the first backing plate 114A in place.

Referring back to FIG. 1, the first test fixture 102 is configured to move along the longitudinal axis 126 in a first direction, perpendicular to the central plane 122, in response to a first applied force F₁, which is applied in the first direction. The second test fixture 104 may either move along the longitudinal axis 126 in a second direction, opposite of the first direction, in response to a second applied force F₂equal in magnitude to the first applied force F₁ but applied in the second direction, or remain fixed while the first test fixture 102 moves. Alternatively, the second test fixture 104 may move while the first test fixture 102 remains fixed. The first applied force F₁ and the second applied force F₂may be equal and opposite tensile forces, or one force may be applied to one test fixture in one direction while the opposite test fixture remains stationary. The applied force generates a tension load on a testing specimen secured to and extending between the test fixtures 102, 104. This configuration helps ensure that the applied force remains balanced and uniformly distributed across a testing specimen, which enables accurate evaluation of the mechanical characteristics under tensile loading.

The first test fixture 102 and the second test fixture 104 are configured to be repositionable relative to each other while maintaining the mirrored orientation across the central plane 122, which enables the test fixtures 102, 104 to accommodate testing specimens of different sizes and/or having features with different radii. That is, the test fixtures 102, 104 can be adjusted to account for differences in testing specimen width and/or curvature while preserving alignment along the longitudinal axis 126. Maintaining the mirrored orientation helps ensure that the forces remain symmetrically distributed, preventing unintended bending or asymmetrical stress concentrations. Additionally, the repositionability improves the versatility of the tension testing tool 100, to enable controlled application of different loading conditions while ensuring that the mechanical response of the testing specimen is evaluated under consistent and repeatable conditions.

The tension testing tool 100 is configurable for multiple test setups to evaluate a testing specimen of the same size under different loading conditions. Specifically, the first test fixture 102 and the second test fixture 104 can be positioned in various mirrored orientations relative to the central plane 122 to enable controlled variations in force distribution without altering dimensions of the testing specimen.

As shown in FIGS. 4A-4C, a testing specimen 202 is secured within the tension testing tool 100 for evaluation. The testing specimen 202 is a curved composite structure designed to evaluate interlaminar mechanical properties under controlled loading conditions. The testing specimen 202 is a multi-layer composite structure, composed of fiber-reinforced polymeric plies bonded together with a matrix material (e.g., epoxy, bismaleimide, or cyanate ester). In some examples, the testing specimen 202 is tested to analyze interlaminar tension (ILT) strength and failure mechanisms such as delamination and crack propagation.

Each testing specimen 202 has a defined radius R, which influences the distribution of bending and axial forces during testing. The tension testing tool 100 is configurable for use with testing specimens having different radii, which enables evaluation of curvature-dependent mechanical behaviors across a range of radii. In some examples, the testing specimen 202 has a radius R between, and inclusive of, two to ten inches, while in other examples, the radius R is between, and inclusive of, three to seven inches. For example, the testing specimen 202 may have a radius R of approximately four inches.

The testing specimen 202 includes a first attachment portion 204 and a second attachment portion 206, which are spaced apart by an intermediate testing portion 208. The intermediate testing portion 208 exhibits a curved profile defined by the radius R. Specifically, the first attachment portion 204 is secured by the first test fixture 102 and the second attachment portion 206 is secured by the second test fixture 104, which helps to ensure that the testing specimen 202 remains fixed while subjected to loading conditions during testing.

FIGS. 4A-4C illustrate different configurations of the tension testing tool 100, where the positioning of the first test fixture 102 relative to the second test fixture 104, and the orientation of the testing specimen 202 relative to the tension testing tool 100 are varied to achieve different force distributions. Although shown with three different configurations, the tension testing tool 100 could have more or fewer than the three configurations shown based on the number of arm-attachment openings 110 in each main body 108. In some examples, the tension testing tool 100 is configured to operate in at least one of an axial-dominant condition (e.g., FIG. 4A), a balanced loading condition (e.g., FIG. 4B), or a bending-dominant condition (e.g., FIG. 4C). The axial-dominant condition corresponds to configurations where the moment arm is shortest, resulting in a force distribution with a higher proportion of axial load relative to bending moment. The balanced loading condition corresponds to an intermediate moment arm length, where both axial and bending loads contribute meaningfully to the overall force distribution. The bending-dominant condition corresponds to the longest moment arm, producing the highest bending moment relative to axial load. Operation of the tension testing tool 100 in at least one of the axial-dominant condition, the balanced loading condition, or the bending-dominant condition is based at least partially on the mirrored orientation of the first test fixture 102 and the second test fixture 104 relative to each other and a selected one of the arm-attachment openings 110 to which the load application arm 120 is attached.

As shown in FIG. 4A, the first test fixture 102 and the second test fixture 104 are oriented such that the first retention surface 112 of both the first main body 102 and the second main body 104 are positioned at an angle inward toward each other relative to the central plane 122. The testing specimen 202 is secured between the test fixtures 102, 104, with the intermediate testing portion 208 curving outward, away from the first retention surfaces 112. That is, the curvature of the intermediate testing portion 208 extends outward, such that the convex side of the testing specimen 202 faces toward the inclined surface 113 of the test fixtures 102, 104.

The load application arms 120 are attached at the second arm-attachment opening 110-2, which is positioned at a greater height from the top surface 111 and a lesser distance from the first retention surface 112 compared to the first arm-attachment opening 110-1. Because the perpendicular distance from the load application axis 126 to the center of the radius R is shorter, the resulting moment arm is reduced, leading to a force distribution with a greater proportion of axial load relative to bending moment. The lower height also minimizes rotational effects, leading to more direct force transmission along the longitudinal axis 126 of the tension testing tool 100. Consequently, when a tensile force is applied to at least one of the load application arms 120, the tensile force generates a greater ratio of axial load relative to bending moment, such that this configuration is an example of an axial-dominant condition. This configuration primarily subjects the testing specimen 202 to axial tension while minimizing bending-induced stresses, to enable evaluation of interlaminar tensile strength under predominantly axial loading.

Although not shown, the tension testing tool 100 could also be used with the load application arms 120 attached to the first arm-attachment opening 110-1 while maintaining the same orientation of the testing specimen 202 and overall geometry shown in FIG. 4A. In this example, applying a load through 110-1 would cause the radius R to close (i.e., induce interlaminar compression), due to the line of action passing outside of the radius R (i.e., on the convex side). While this variation may be useful for investigating interlaminar compression behavior, it is not suitable for evaluating interlaminar tension failure modes, such as delamination. To induce an opening moment at the radius R, the line of action must pass through the testing specimen 202 on the concave side of the radius R (i.e., the right side as shown in FIG. 4A).

In other examples, the first attachment portion 204 and the second attachment portion 206 may be extended in length, such that when the first test fixture 102 and the second test fixture 104 are attached to the ends of the testing specimen 202, the fixtures are positioned farther apart across the central plane 122. Compared to the configuration of FIG. 4A, this increased spacing causes the radius R to shift farther away from the load application axis 126, increasing the perpendicular distance (i.e., the moment arm) from the radius R to the line of action. In this configuration, the applied force generates a greater bending moment, resulting in a more bending-dominant condition. Thus, even when using the same attachment location (110-2), variations in the geometry of the testing specimen can influence whether the applied force produces a more axial-dominant or bending-dominant response.

As shown in FIG. 4B, the first test fixture 102 and the second test fixture 104 are oriented such that the first retention surface 112 of both the first main body 108A and the second main body 108B are positioned at an angle outward, away from each other relative to the central plane 122. The testing specimen 202 is secured between the test fixtures 102, 104, with the intermediate testing portion 208 curving inward, toward the longitudinal axis 126. That is, the curvature of the intermediate testing portion 208 extends inward, such that the concave side of the testing specimen 202 faces toward the inclined surfaces 113 of the test fixtures 102, 104.

Similar to FIG. 4A, in FIG. 4B, the load application arms 120 are also attached to the second arm-attachment opening 110-2, positioning the applied force at a greater height from the top surface 111 and lesser distance from the first retention surface 112. However, due to the outward orientation of the test fixtures 102, 104, the force distribution results in a more balanced combination of bending and axial loading rather than being primarily axial as in FIG. 4A. The inclination of the test fixtures 102, 104 introduces a moderate bending effect, creating a more distributed force condition. Accordingly, the applied force generates a more balanced distribution between axial and bending loads, such that this configuration is an example of a balanced loading condition. A balanced loading condition does not require the axial and bending loads to be equal but instead refers to a condition where the bending and axial components contribute meaningfully to the overall force distribution without one dominating the response of the testing specimen 202. This balance ensures that interlaminar tensile strength is evaluated under conditions where both axial tension and bending-induced stresses influence the mechanical behavior of the composite structure.

FIG. 4C illustrates a configuration similar to FIG. 4B, in which the first test fixture 102, the second test fixture 104, and the testing specimen 202 maintain the same relative orientation. However, in this configuration, the load application arms 120 are attached at the first arm-attachment opening 110-1 in each test fixture, resulting in a larger moment arm compared to the configuration shown in FIG. 4B, where the load application arms 120 are attached at the second arm-attachment opening 110-2, which is positioned at a lesser height from the top surface 111 and greater distance from the first retention surface 112. Due to the increased moment arm, the applied force generates a higher bending moment relative to the axial load, such that this configuration is an example of a bending-dominant loading condition. This configuration enables greater bending-induced stresses to be introduced into the testing specimen 202 while still maintaining axial tension, to enable the evaluation of interlaminar tensile strength under a bending-dominant loading scenario. Accordingly, by comparing the responses of the testing specimen 202 across FIGS. 4A–4C, different force distributions can be analyzed to assess how curvature and loading conditions influence failure mechanisms such as delamination and crack propagation.

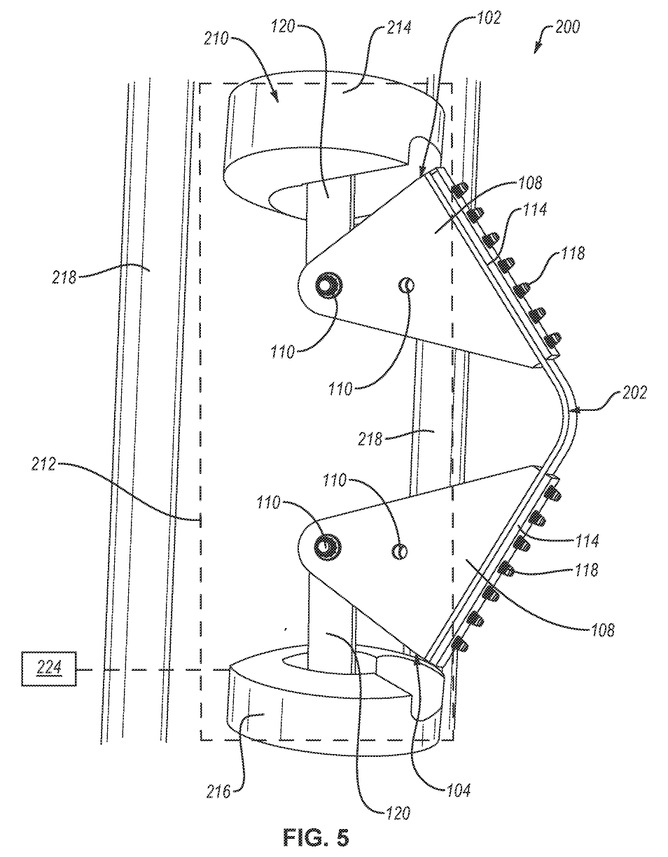

Referring to FIG. 5, one example of a tension testing system 200 is shown with the tension testing tool 100 removably secured to a testing frame 210. As shown, the tension testing tool 100 and the secured testing specimen 202 are in a bending-dominant loading condition as shown in FIG. 4C. However, the testing frame 210 is adaptable to accommodate any configuration of the tension testing tool 100, to enable controlled evaluation of different force distributions across a secured testing specimen 202. Specifically, the testing frame 210 is a structural assembly configured to apply controlled tensile forces to the tension testing tool 100 and the secured testing specimen 202. The testing frame 210 includes a load application system 212, which is configured to control the magnitude and rate of the force applied during testing. The load application system 212 includes an upper crosshead 214, a lower crosshead 216, and a support structure 218 that houses and stabilizes the loading components.

During testing, the first test fixture 102 is removably secured to the upper crosshead 214 and the second test fixture 104 is removably secured to the lower crosshead 216 of the testing frame 210. The test fixtures 102, 104 remain spaced apart and maintain a mirrored orientation across the central plane 122. In some examples, the upper crosshead 214 moves along the longitudinal axis 126, applying the first applied force F₁, while the lower crosshead 216 remains fixed. In other examples, both the upper crosshead F₁ and the lower crosshead 216 move relative to each other, applying the first applied force F₁ and the second applied force F₂ in opposite directions along the longitudinal axis 126. In yet other examples, the lower crosshead 216 moves while the upper crosshead 214 remains fixed. The support structure 218 maintains alignment of the tension testing tool 100 within the testing frame 210, preventing unintended lateral displacement or misalignment of the test fixtures 102, 104.

Each of the test fixtures 102, 104 secures a respective retaining portion of the testing specimen 202. Specifically, the first attachment portion 204 of the testing specimen 202 is removably secured between the first retention surface 112 of the main body 108 and the second retention surface 116 of the backing plate 114 of the first test fixture 102, while the second attachment portion 206 is similarly secured between the first retention surface 112 of the main body 108 and the second retention surface 116 of the backing plate 114 of the second test fixture 104. The intermediate testing portion 208 extends in the space between the first test fixture 102 and the second test fixture 104.

In some examples, the testing frame 210 is a material testing system frame, such as a servo-hydraulic, electromechanical, or manually operated tensile testing machine. The load application system 212 may further include force sensors and displacement control mechanisms to facilitate controlled loading sequences for evaluating interlaminar tensile strength under various conditions. Additionally, in some examples, a control system 224 is operably coupled to the load application system 212 and is configured to regulate loading sequences based on real-time measurements. The control system may operate in either displacement control or load control mode while simultaneously monitoring the other parameter, to ensure precise force application. The control system 224 may record applied force magnitudes, force distribution, and load response characteristics at various stages of testing to enable detailed analysis of mechanical behavior, including interlaminar tensile strength and failure mechanisms.

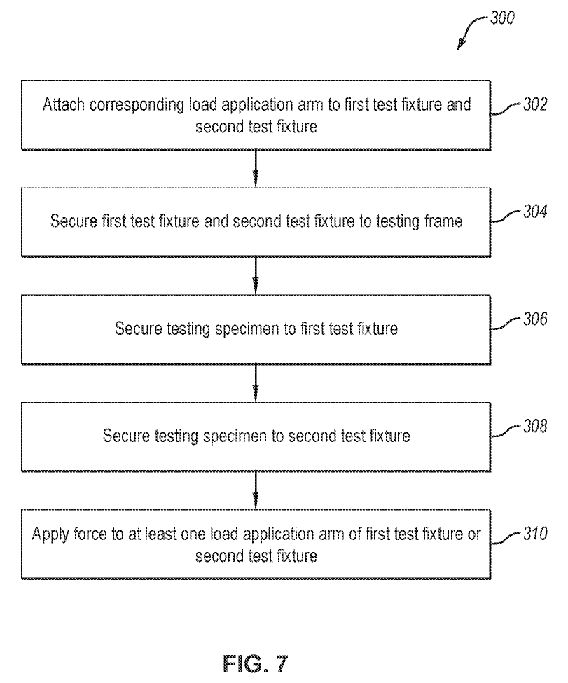

Referring to FIG. 7, a method 300 of performing a tension test on a testing specimen 202 is shown. The method 300 includes (block 302) attaching a first load application arm 120A to a main body 108 of a first test fixture 102 and a second load application arm 120B to a main body 108 of a second test fixture 104 via an arm-attachment opening 110 in each main body 108. In some examples, the test fixtures 102, 104 may include multiple arm-attachment openings 110, to enable the load application arm 120 to be attached at a selected one of the arm-attachment openings 110 to adjust the moment arm length and modify the ratio of axial to bending loads applied to the testing specimen.

Each one of the arm-attachment openings 110 in the first test fixture 102 has a corresponding one of the arm-attachment openings 110 in the second test fixture 104 that is positioned in a mirrored orientation across the central plane 122. The first load application arm 120A is attached to a selected one of the arm-attachment openings 110 in the first test fixture 102 and the second load application arm 120B is attached to a corresponding one of the arm-attachment openings 110 in the second test fixture 104. The load application arms 120 may be rigidly secured to the main body 108 or pivotably coupled to enable dynamic force redistribution during testing. In some examples, a pin 124 is used to attach the load application arm 120 to the main body 108.

The method also includes (block 304) removably securing the first test fixture 102 and the second test fixture 104 to a testing frame 210, such that the first test fixture 102 and the second test fixture 104 are spaced apart and mirror each other across the central plane 122. The test fixtures 102, 104 may be secured using any of various securement mechanisms, including mechanical clamps, hydraulic locking systems, or custom-fixture adapters. In some examples, the testing frame 210 may include adjustable mounting positions to accommodate different testing specimen sizes and orientations while maintaining proper alignment during testing.

The method further includes (block 306) securing a first attachment portion 204 of a testing specimen 202 between a first retention surface 112 of the main body of the first test fixture 102 and a second retention surface 116 of a backing plate 114 of the first test fixture 102. Additionally, the method includes (block 308) securing a second attachment portion 206 of the testing specimen 202 between a first retention surface 112 of the main body 108 of the second test fixture 104 and a second retention surface 116 of a backing plate 114 of the second test fixture 104. The first attachment portion 204 is spaced apart from the second attachment portion 206 by an intermediate testing portion 208 of the testing specimen 202. The first retention surface 112 and the second retention surface 116 may be textured, coated, or contoured to enhance grip and minimize slippage. In some examples, fasteners are utilized to removably attach the backing plate to the main body. The testing specimen may be secured to the test fixtures 102, 104 in one of an axial-dominant condition, a balancing loading condition, and a bending-dominant condition.

The method finally includes (block 310) applying a force to at least one of the first load application arm 120A and the second load application arm 120B along a longitudinal axis to assess mechanical characteristics in the testing specimen 202. The force may be adjusted in magnitude and rate to simulate different loading conditions. The force may be applied as opposing forces, where each of the crossheads of the testing frame 210 applies an equal and opposite force. Alternatively, a single force may be applied to one of the crossheads while the other crosshead remains fixed. In some examples, the testing frame 210 applies tensile loading to the testing specimen 202 until structural failure occurs. In some examples, the system may record failure load and displacement using the testing frame 210. The collected data is used to compute bending moments and axial stresses. The results may help generate design values for composite materials and inform predictive strength models for future components, such as composite components for aerospace applications.

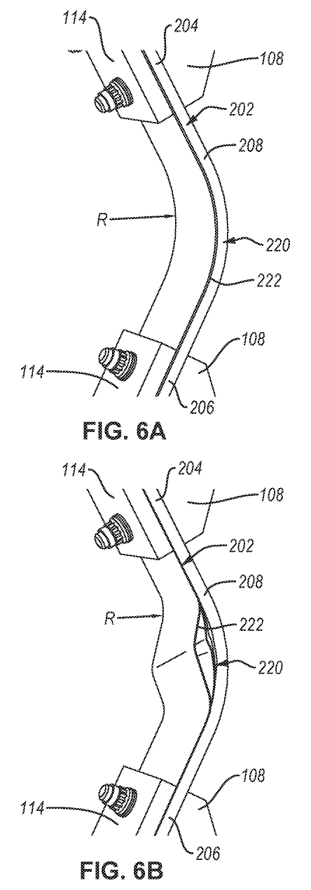

As the force is applied, the response of the testing specimen 202 can be observed to evaluate its structural integrity. As shown in FIG. 6A, the testing specimen 202 is secured within the tension testing tool 100 and subjected to applied tensile force along the longitudinal axis 126 (see, i.e., FIG. 1). The testing specimen is a curved composite structure 220. The first attachment portion 204 and the second attachment portion 206 are clamped between the respective test fixtures 102, 104, while the intermediate testing portion 208 remains exposed to the induced axial and bending loads. At this stage, the testing specimen 202 experiences internal stress distributions due to the applied forces, but the composite structure remains intact. The interlaminar layers of the testing specimen 202 are still fully bonded, and no visible delamination or separation is observed.

As shown in FIG. 6B, following continued application of force, the testing specimen 202 exhibits interlaminar failure, characterized by at least one ply of the plurality of fiber-reinforced plies of the curved composite structure 220 separating along an internal plane. The failure region is visible within the intermediate testing portion 208, where delamination has occurred. Specifically, a portion of the material has detached, forming a separation gap 222, which indicates a loss of structural integrity between composite plies. This failure mode is indicative of interlaminar tension failure, where the applied loads exceeded the adhesion strength between fiber-reinforced plies, causing the material to split along its bonded layers.

Accordingly, by applying the force in a controlled manner, the system enables analysis of stress distributions, deformation behaviors, and failure mechanisms under combined axial and bending loads. The ability to capture the transition from an intact composite structure (e.g., FIG. 6A) to interlaminar failure (e.g., FIG. 6B) provides important insights into the performance and durability of composite materials in real-world applications.

In the above description, certain terms may be used such as "up," "down," "upper," "lower," "horizontal," "vertical," "left," "right," “over,” “under” and the like. These terms are used, where applicable, to provide some clarity of description when dealing with relative relationships. But, these terms are not intended to imply absolute relationships, positions, and/or orientations. For example, with respect to an object, an "upper" surface can become a "lower" surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.” Moreover, unless otherwise noted, as defined herein a plurality of particular features does not necessarily mean every particular feature of an entire set or class of the particular features.

The term “about” or “substantially” in some embodiments, is defined to mean within +/-5% of a given value, however in additional embodiments any disclosure of “about” may be further narrowed and claimed to mean within +/- 4% of a given value, within +/- 3% of a given value, within +/- 2% of a given value, within +/- 1% of a given value, or the exact given value. Further, when at least two values of a variable are disclosed, such disclosure is specifically intended to include the range between the two values regardless of whether they are disclosed with respect to separate embodiments or examples, and specifically intended to include the range of at least the smaller of the two values and/or no more than the larger of the two values. Additionally, when at least three values of a variable are disclosed, such disclosure is specifically intended to include the range between any two of the values regardless of whether they are disclosed with respect to separate embodiments or examples, and specifically intended to include the range of at least the A value and/or no more than the B value, where A may be any of the disclosed values other than the largest disclosed value, and B may be any of the disclosed values other than the smallest disclosed value.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms "first," "second," etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

The schematic flow chart diagrams included herein are generally set forth as logical flow chart diagrams. As such, the depicted order and labeled steps are indicative of one example of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present subject matter may be embodied in other specific forms without departing from its spirit or essential characteristics. The described examples are to be considered in all respects only as illustrative and not restrictive. All changes which come within the meaning and range of equivalency of the claims are to be embraced within their scope.

What is claimed is:

1. A tension testing tool comprising:
a first test fixture and a second test fixture each comprising:
a main body comprising an arm-attachment opening and a first retention surface;
a backing plate comprising a second retention surface;
fasteners configured to removably secure the backing plate to the main body; and
a load application arm removably attachable to the arm-attachment opening of the main body;
wherein:
the first retention surface of the main body and the second retention surface of the backing plate are spaced apart and face each other when the fasteners removably secure the backing plate to the main body; and
a gap defined between the first retention surface and the second retention surface is configured to receive and retain a testing specimen;
wherein the first test fixture and the second test fixture are spaced apart and mirror each other across a central plane.

2. The tension testing tool of claim 1, wherein, at least one of:
the first test fixture is configured to move along a longitudinal axis in a first direction, perpendicular to the central plane, in response to a first applied force; and
the second test fixture is configured to move along the longitudinal axis in a second direction, opposite the first direction, in response to a second applied force equal to the first applied force.

3. The tension testing tool of claim 1, wherein each one of the first test fixture and the second test fixture further comprises a pin configured to extend through the arm-attachment opening of the main body and an opening in the load application arm.

4. The tension testing tool of claim 1, wherein, for each one of the first test fixture and the second test fixture, the load application arm is pivotable relative to the main body, when the load application arm is attached to the arm-attachment opening of the main body.

5. The tension testing tool of claim 1, wherein each one of the first test fixture and the second test fixture, comprises multiple arm-attachment openings, wherein the arm-attachment opening is one of the arm-attachment openings.

6. The tension testing tool of claim 1, wherein, for each one of the first test fixture and the second test fixture:
the arm-attachment opening comprises a first arm-attachment opening and a second arm-attachment opening; and
the first arm-attachment opening is further away from the first retention surface of the main body than the second arm-attachment opening.

7. The tension testing tool of claim 6, wherein, for at least one of the first test fixture and the second test fixture,
when the load application arm is attached to the first arm-attachment opening, a force applied to the load application arm is transmitted through the main body as a combination of a first bending and axial load;
when the load application arm is attached to the second arm-attachment opening, the force applied to the load application arm is transmitted through the main body as a combination of a second bending and axial load; and
the first bending and axial load is different from the second bending and axial load.

8. The tension testing tool of claim 1, wherein the first retention surface of the main body of the first test fixture is positioned at an oblique angle relative to the first retention surface of the main body of the second test fixture.

9. The tension testing tool of claim 1, wherein the first test fixture and the second test fixture are configured to be repositionable relative to each other while maintaining a mirrored orientation across the central plane.

10. A tension testing system, comprising:
a first test fixture and a second test fixture each comprising:
a main body comprising an arm-attachment opening and a first retention surface;
a backing plate comprising a second retention surface;
fasteners configured to removably secure the backing plate to the main body;
a load application arm removably attachable to the arm-attachment opening of the main body; and
a testing frame;
wherein, during testing:
the first test fixture and the second test fixture are removably secured to the testing frame, such that the first test fixture and the second test fixture are spaced apart and mirror each other across a central plane;
a first retention surface of the main body of the first test fixture is positioned at an oblique angle relative to the first retention surface of the main body of the second test fixture;
a first attachment portion of a testing specimen is removably secured between the first retention surface of the main body and the second retention surface of the backing plate of the first test fixture and a second attachment portion of the testing specimen is removably secured between the first retention surface of main body and the second retention surface of the backing plate of the second test fixture, the first attachment portion being spaced apart from the second attachment portion by an intermediate testing portion of the testing specimen; and
the testing frame applies a force to at least one of the load application arms of the first test fixture and the load application arm of the second test fixture along a longitudinal axis to assess mechanical characteristics in the testing specimen.

11. The tension testing system of claim 10, wherein, at least one of:
the first test fixture is configured to move along the longitudinal axis in a first direction, perpendicular to the central plane, in response to a first applied force; and
the second test fixture is configured to move along the longitudinal axis in a second direction, opposite the first direction, in response to a second applied force equal to the first applied force.

12. The tension testing system of claim 10, wherein the first test fixture and the second test fixture are adjustably positionable relative to the testing frame and to each other to accommodate testing specimens of various sizes.

13. The tension testing system of claim 10, wherein the testing frame comprises a load application system configured to control a magnitude of the force and a rate at which the force is applied to at least one of the load application arms of the first test fixture and the load application arm of the second test fixture.

14. The tension testing system of claim 10, wherein each one of the first test fixture and the second test fixture, comprises multiple arm-attachment openings, wherein the arm-attachment opening is one of the arm-attachment openings.

15. The tension testing system of claim 14, wherein:
the first test fixture and the second test fixture are positionable relative to each other in different mirrored orientations relative to the testing frame;
the tension testing system is configured to operate in at least one of an axial-dominant condition, a balanced loading condition, or a bending-dominant condition; and
operation of the tension testing system in at least one of the axial-dominant condition, the balanced loading condition, or the bending-dominant condition is based at least partially on the mirrored orientation of the first test fixture and the second test fixture relative to the testing frame and a selected one of the arm-attachment openings to which the load application arm is attached.

16. A method of performing a tension test on a testing specimen, the method comprising:
attaching a first load application arm to a main body of a first test fixture and a second load application arm to a main body of a second test fixture via an arm-attachment opening in each main body;
removably securing the first test fixture and the second test fixture to a testing frame, such that the first test fixture and the second test fixture are spaced apart and mirror each other across a central plane;
securing a first attachment portion of a testing specimen between a first retention surface of the main body of the first test fixture and a second retention surface of a backing plate of the first test fixture;
securing a second attachment portion of the testing specimen between a first retention surface of the main body of the second test fixture and a second retention surface of a backing plate of the second test fixture, a first attachment portion being spaced apart from the second attachment portion by an intermediate testing portion of the testing specimen; and
applying a force to at least one of the first load application arm and the second load application arm along a longitudinal axis to assess mechanical characteristics in the testing specimen.

17. The method of claim 16, wherein:
each one of the first test fixture and the second test fixture, comprises multiple arm-attachment openings, wherein the arm-attachment opening is one of the arm-attachment openings;
each one of the arm-attachment openings in the first test fixture have a corresponding one of the arm-attachment openings in the second test fixture that is positioned in a mirrored orientation across the central plane; and
the step of attaching the first load application arm and the second load application arm further comprises attaching the first load application arm to a selected one of the arm-attachment openings in the first test fixture and attaching the second load application arm to a corresponding one of the arm- attachment openings in the second test fixture.

18. The method of claim 17, further comprising selecting a mirrored orientation of the first test fixture and the second test fixture relative to the testing frame;
wherein the step of applying the forces to at least one of the first load application arm and the second load application arm results in at least one of an axial-dominant condition, a balanced loading condition, or a bending-dominant condition based at least partially on the mirrored orientation of the first test fixture and the second test fixture relative to the testing frame and the selected one of the arm-attachment openings to which the first load application arm and the second load application arm are attached.

19. The method of claim 16, wherein the step of applying the force further comprises controlling a magnitude of the force and a rate at which the force is applied to at least one of the load application arms of the first test fixture and the load application arm of the second test fixture.

20. The method of claim 16, further comprising adjusting a position of the first test fixture and the second test fixture relative to each other and relative to the testing frame to accommodate a size of the testing specimen.
